(19) United States
(12) Patent Application Publication
(10) Pub. No.: US 2011/0145720 A1
(43) Pub. Date: Jun. 16, 2011

(54) Feeds for Address Books

(76) Inventors: Jay Oliver Glasgow, Acworth, GA (US); Precia Carraway, Atlanta, GA (US)

(21) Appl. No.: 12/638,513

(22) Filed: Dec. 15, 2009

(51) Int. Cl. G06F 3/048; G06F 15/16

(52) U.S. Cl. 715/739

(57) ABSTRACT

A feed system for an address book includes a news feed module and a sales feed module. The news feed module accesses news sources to find related news articles as a function of data in an address book. The sales feed module accesses sales sources to find related sales items as a function of the data in the address book. At least one of the news feed module and the sales feed module forwards the related news articles and the related sales items, respectively, to the address book to be displayed.

### BACKGROUND

An electronic address book may include a plurality of contacts that is personalized. The contacts may be manually input into the address book. The contacts may also be selected from a public contact list such as a Yellow Pages. The contacts may be, for example, an individual or a company. The contacts may further include information respectively related thereto such as an address, a telephone number, a fax number, email, etc.

The electronic address book may further be configured to enable a contact to be created from an option provided by an individual or company. For example, a webpage for a business may include an option to create a contact for the address book. Thus, when a user selects the option, a new contact is created. Although the electronic address book includes many different options such as the contact list, a calendar, and other personalized options, the address book is limited to the information that is fed thereto which is usually restricted to manually selected data.

### SUMMARY OF THE INVENTION

The exemplary embodiments of the present invention describe a feed system for an address book comprising a news feed module and a sales feed module. The news feed module accesses news sources to find related news articles as a function of data in an address book. The sales feed module accesses sales sources to find related sales items as a function of the data in the address book. At least one of the news feed module and the sales feed module forwards the related news articles and the related sales items, respectively, to the address book to be displayed.

### DESCRIPTION OF THE DRAWINGS

FIG. 1 shows a feed system for an address book according to an exemplary embodiment.

FIG. 2 shows a method for feeding data to an address book according to an exemplary embodiment.

### DETAILED DESCRIPTION

The exemplary embodiments may be further understood with reference to the following description and the appended drawings, wherein like elements are referred to with the same reference numerals. The exemplary embodiments describe a feed system and method for providing data to an address book. Specifically, the system and method may be configured to provide data related to searches and/or contacts of the address book automatically and/or manually. The address book, feed system, contacts, and a related method will be discussed in further detail below.

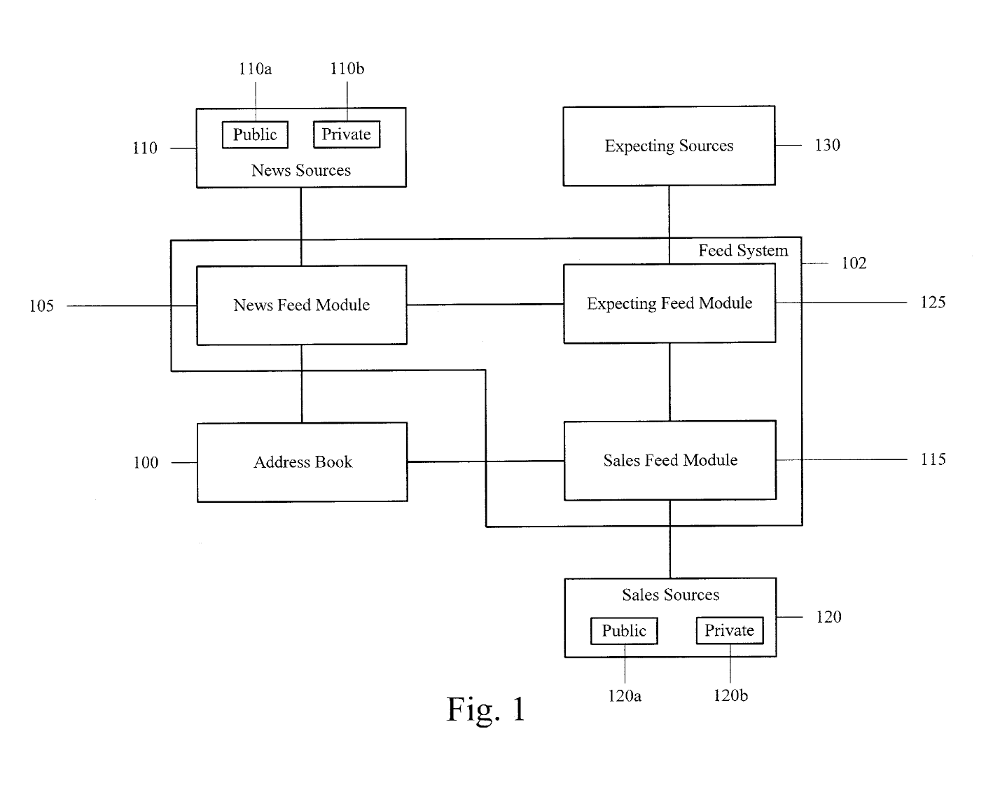

FIG. 1 shows a feed system 102 for an address book 100 according to an exemplary embodiment. The address book 100 may enable a user to add contacts manually or automatically. Contacts may be added manually when the user inputs specified information relating to the contacts through a user interface of the address book 100. Contacts may be added automatically when the user selects to enable an outside user to input contact data. The contacts of the address book 100 may include individuals or entities. According to an exemplary embodiment, the address book 100 may be a personalized Yellow Pages (PYP) in which the user may selectively include business oriented contacts. According to another exemplary embodiment, the address book 100 may include access to a Yellow Pages through the user interface of the address book 100. The PYP may be used as a partial basis for the feed system 102 to determine types of data to provide to the address book. The feed system 102 may include a news feed module 105, a sales feed module 115, and an expecting feed module 125.

The news feed module 105 may be configured to determine related news articles for the contacts and information related thereto of the address book 100. For example, if a contact of the address book 100 relates to a doctor, the news feed module 105 may reference news articles with the information related to the doctor. Thus, if a news article contains an item for the building in which the doctor works, the news feed module 105 may determine a level of relevance that the article has in relation to the contact information of the address book 100.

The news feed module 105 may be connected to news sources 110. The news sources 110 may include public items 110a and/or private items 110b. The public items 110a of the news sources 110 may be any item that is publicly accessed such as news websites that are viewable through a browser without any authentication requirement. The private items 110b of the news sources 110 may be any item that is privately accessed such as privileged sources (e.g., company newsletter) that may require a subscription.

When the address book 100 is launched, the news feed module 105 may search the news sources 110 for related articles using the loaded contacts of the address book 100.

In a first exemplary embodiment, when the news feed module 105 finds a related news article, the news feed module 105 may push the article to the address book 100. For example, the news feed module 100 may relay the news article by showing an icon or link on the address book 100 in which the user may manually select so that a browser opens and forwards the universal resource locator (url) of the news article. In another example, when the news feed module 105 finds multiple news articles, the icon shown in the address book may include a counter or option to display the various news articles that were found. The options may include a superimposed box showing a list of the news articles when the user scrolls over the icon or a pull down menu.

In a second exemplary embodiment, the address book 100 may include a predetermined location on the user interface designated to show at least a portion of the found news article. The predetermined location may be configured so that a user may manually select to be forwarded to the news article itself. When the news feed module 105 finds multiple news articles, the predetermined location may cycle through the news articles and show each article for a predetermined amount of time.

In a third exemplary embodiment, the address book 100 may be manually configured so that news articles found by the news feed module 105 are automatically shown (e.g., browser is automatically opened to the news article url).

As discussed above, the address book 100 may be a PYP or provide access to a Yellow Pages. Thus, the user may perform searches of a Yellow Pages for results prior to including contacts to the address book 100. When the search is performed, the news feed module 105 may find news articles from the news sources 100 relating to the search criteria entered. The found news articles may be incorporated into the address book 100 using any of the above methods.

The sales feed module 115 may function in a substantially similar way as the news feed module 105. For example, the sales feed module 115 may access sales sources 120 which may include private sales 120a and/or public sales 120b. The sales feed module 115 may find sales items that relate to the contacts of the address book 100 (e.g., upon launch of the address book 100) or from search results of the Yellow Pages. In a substantially similar manner as the news feed module 105, the address book 100 may display an icon or link relating to the found sales item; the address book 100 may have a predetermined area to show the found sales items; and/or the address book 100 may automatically show the found sales items. The icon or link to the sales item provided by the sales feed module 115 may also directly connect the user to the sales item by opening a browser at the url for the vendor.

The sales feed module 115 may additionally use results of the news feed module 105 to find sales items from the sales sources 120. For example, if a news article found by the news feed module 105 relates to an opening of a new store, the sales feed module 115 may use this information to find sales items in which the new store may be advertising itself or related sales items in which the store may sell.

The sales feed module 115 may further be configured to find sales items based upon the contacts and/or searches of the address book 100. For example, the user of the address book 100 may configure the sales feed module 115 to restrict searches of the sales sources 120 to sales items that are available within a predetermined distance from the user's location. Thus, the sales feed module 115 may include a relevance determination based upon manually entered restrictions or automatically determined from the data of the address book 100. The relevance of the found sales items may also go through a filter to restrict items to be shown so random objects are not displayed. However, it should be noted that in an absence of criteria to base a search for sales items, the sales feed module 115 may base searches randomly or upon previously used criteria.

According to the exemplary embodiments, the news feed module 105 and the sales feed module 115 may be used for the address book 100 when the user of the address book 100 is authenticated. That is, the news feed module 105 and/or the sales feed module 115 may have access to a list of users who are authorized and the services provided by the modules may become available if the user is on the list. It should be noted that if the user is not authorized, then the news feed module 105 and the sales feed module 115 may include generalized functionalities such as providing advertisements or general sales/news items that are found.

The news feed module 105 and the sales feed module 115 may further include extended searches. That is, the modules may search the respective sources for items that is within relevance of the base criteria. For example, if a news item is found relating directly to a search of a restaurant (e.g., grand opening of the restaurant), the news feed module 105 may also search for related items such as finding news articles of the food served at the restaurant whereas the sales feed module 115 may also search for related sales items for the food served at the restaurant.

The feed system 102 may further include the expecting feed module 125. The expecting feed module 125 may search expecting sources 130 for related items that the news feed module 105 and/or the sales feed module 115 find. The expecting sources 130 may be a database of potential items to come. For example, the expecting sources 130 may include a store which is opening at a future time. Thus, the expecting feed module 125 may determine that the news feed module 105 has found an article about a further, currently established store selling comparable items. The expecting feed module 125 may feed the information relating to the store to be displayed in the address book 100, thereby notifying the user that the store is coming soon.

In a first exemplary embodiment and in a substantially similar manner as the news feed module 105 and the sales feed module 115, the expecting feeds module 125 may display an icon or link relating to the found expecting item; the address book 100 may have a predetermined area to show the found expecting items; and/or the address book 100 may automatically show the found expecting items. The icon or link to the expecting item provided by the expecting feed module 125 may also directly connect the user to the source that indicates the expectancy of the item, thereby enabling a user to determine an expectant date and/or further details regarding the item. In a second exemplary embodiment, the results of the expecting feed module 125 may be respectively incorporated with the results found with the news feed module 105 and/or the sales feed module 115.

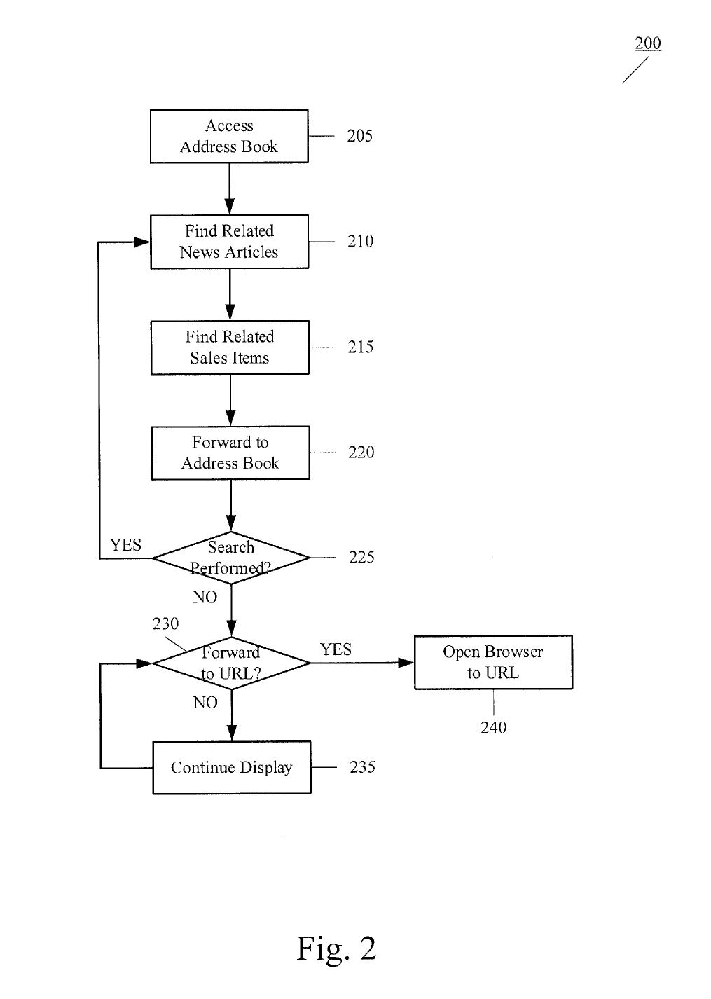

FIG. 2 shows a method 200 for feeding data using a feed system 102 to the address book 100 according to an exemplary embodiment. The method 200 will be described with respect to the feed system 102. The method 200 will also be described with reference to the address book 100, the feed system 102, and the sources described in FIG. 1.

In step 205, the feed system 102 accesses the address book 100. As described above, the news feed module 105 and the sales feed module 115 may both access the address book 100. The access to the address book 100 may relate to the contacts included in the address book 100 or a prior history of the address book 100.

In step 210, the news feed module 105 refers to the news sources 110 to find related news articles based upon the access to the address book 100. As discussed above, the news sources 110 may include public sources 110a which may be accessed by anyone without an authentication requirement or private sources 110b which may only be accessed by authenticated users. The news feed module 105 may include a list of authenticated users and respective sources to which access of private sources 110b is granted. Also as discussed above, the news feed module 105 may include a variety of different searches with respect to the user of the address book 100. For example, if the user of the address book 100 is not a validated user of the feed system 102, the news feed module 105 may generally search for news articles in the public sources 110a. In another example, if the user of the address book 100 is a validated user of the feed system 102, the news feed module 105 may access a user history (e.g., prior searches) and/or the contacts to perform the search of the news sources 110. It should be noted that the news feed module 105 may also receive data from the expecting feed module 125 for related sales items for the address book 100.

In step 215, the sales feed module 115 refers to the sales sources 120 to find related sales items based upon the access to the address book 100. As discussed above, the sales sources 120 may also include public sources 120a which may be accessed by anyone without an authentication requirement or private sources 120b which may only be accessed by authenticated users. In a substantially similar manner as the news feed module 105, the sales feed module 105 may include a list of authenticated users and respective sources to which access of private sources 120b is granted. Furthermore, in a substantially similar manner as the news feed module 105, the sales feed module 105 may include a variety of different searches with respect to the user of the address book 100. It should be noted that the sales feed module 115 may also receive data from the expecting feed module 125 for related sales items for the address book 100.

In step 220, the news feed module 105 forwards found news articles while the sales feed module 115 forwards found sales items to the address book 100. As discussed above, the address book 100 may receive the articles from the news feed module 105 and the sales feed module 115 and appropriately display the results on a UI. In the first example, the feed system 102 may push the article to the address book 100 by displaying an icon or link that may be selected by the user. The icon or link may include a list or menu, in particular when multiple results are found by the feed system 102. In the second example, the feed system 102 may display the found articles/items in predetermined locations of the UI of the address book 100. In the third example, the found results of the feed system 102 may automatically display the results.

In step 225, the feed system 102 determines if a search is performed on the address book 100. As discussed above, the address book 100 may be a PYP in which a search may be performed to find results in a Yellow Pages. It should also be noted that the search may also be within the data of the address book such as finding a particular contact. When a search is performed, the method 200 returns to step 210 where the news feed module 105 finds news articles related to the search criteria and to step 215 where the sales feed module 115 finds new sales items related to the search criteria. Thus, in step 220, the new articles/items may be forwarded to the address book 100. It should be noted that the search may also refer to the expecting feed module 125 so that results found therein may also be forwarded.

In step 230, the feed system 102 determines if the user has selected to be forwarded to a site that hosts the news article and/or sales item. As discussed above, the news feed module 105 and the sales feed module 115 may provide an icon for the address book 100 so that the user may select to be forwarded to the article/item itself. If the user does not select to be forwarded, the method 200 continues to step 235 where the news article and/or sales item continues to be displayed on the UI of the address book 100. If the user selects to be forwarded, the method 200 continues to step 240 where a browser is opened with the URL that hosts the news article and/or sales item.

It should be noted that the above exemplary method may include further steps to incorporate additional functionalities of the feed system 102. For example, between steps 210 and 215, the method 200 may include a relevance step in which the news feed module 105 determines a relevance value for found news articles with respect to data of the address book 100 and/or a search that was performed. Accordingly, between steps 215 and 220, the method 200 may include a relevance step in which the sales feed module 115 determines a relevance value for found sales items with respect to data of the address book 100 and/or a search that was performed. Using a predetermined threshold value, if the ascertained relevance value exceeds the predetermined threshold value, the respective module may then forward the found result to the address book.

In another example, between steps 210 and 215, the method 200 may include an extended search step in which the news feed module 105 determines extensions to a search criteria to find news articles. Accordingly, between steps 215 and 220, the method 200 may include an extended search step in which the sales feed module 115 determines extensions to a search criteria to find sales items. The extended search step may provide indirect connections in which an article/item may be found. Using, for example, a relevance determination, the found extended article/item may be forwarded by the respective module to the address book 100.

The exemplary embodiments provide a feed system for an address book. The feed system may be configured to search news sources and/or sales sources to forward relevant news articles and/or sales items to the address book to be displayed. A news feed module and a sales feed module of the feed system may access the address book to determine a basis to search for the news articles and the sales items. The feed system may also provide an icon or link for the address book so that a user may be directly forwarded to a source of the news article or sales item. For example, a new browser may open a page in which the news article or sales item is being hosted.

The exemplary embodiments may further provide that the feed system includes an expecting feed module in which the news feed module and/or the sales feed module may be fed data relating to expectant news articles and/or expectant sales items. For example, if a new business is to open, the news feed module may be fed data from the expecting feed module relating to an opening day for the new business. In another example, if the news business is to open, the sales feed module may be fed data from the expecting feed module relating to types of items or sales items for the new business.

Those skilled in the art will understand that the above described exemplary embodiments may be implemented in any number of manners, including as a separate software module, as a combination of hardware and software, etc. For example, the feed system 102 may include the news feed module 105 and the sales feed module 115 which may be embodied as a program containing lines of code that, when compiled, may be executed on a processor.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A feed system, comprising:
a news feed module accessing news sources to find related news articles as a function of data in an address book; and
a sales feed module accessing sales sources to find related sales items as a function of the data in the address book,
wherein at least one of the news feed module and the sales feed module forwards the news articles and the sales items, respectively, to the address book to be displayed.

2. The feed system of claim 1, wherein the data in the address book includes contact information of at least one of individuals and entities.

3. The feed system of claim 1, wherein at least one of the news feed module and the sales feed module further find related news articles and sales items, respectively, as a function of a search performed on the address book.

4. The feed system of claim 1, further comprising:
an expecting feed module accessing expecting sources to find at least one of expectant news-related articles and expectant sales items as a function of the data in the address book.

5. The feed system of claim 4, wherein the expecting feed module feeds the expectant news-related articles and expectant sales items to the news feed module and the sales feed module, respectively.

6. The feed system of claim 5, wherein the news feed module and the sales feed module further forward the expectant news-related articles and expectant sales items to the address book to be displayed.

7. The feed system of claim 1, wherein the news articles and the sales items are displayed on the address book as an icon.

8. The feed system of claim 7, wherein the icon is selectable for redirecting to a host hosting the news article and the sales item.

9. The feed system of claim 7, wherein the icon is configured to be one of a menu and a list when a plurality of news articles and sales items are found by the news feed module and the sales feed module, respectively.

10. The feed system of claim 1, wherein at least one of the news feed module and the sales feed module extends a field of search of the respective sources as a function of an indirect connection to the data of the address book.

11. A computer readable storage medium including a set of instructions executable by a processor, the set of instructions operable to:
access news sources to find related news articles as a function of data in an address book; and
access sales sources to find related sales items as a function of the data in the address book,
wherein the related news articles and related sales items are forwarded to the address book to be displayed.

12. The computer readable storage medium of claim 11, wherein the data in the address book includes contact information of at least one of individuals and entities.

13. The computer readable storage medium of claim 12, wherein the set of instructions are further operable to:
find related news articles and sales items as a function of a search performed on the address book.

14. The computer readable storage medium of claim 11, wherein the set of instructions are further operable to:
access expecting sources to find at least one of expectant news-related articles and expectant sales items as a function of the data in the address book.

15. The computer readable storage medium of claim 14, wherein the expectant news-related articles and expectant sales items are further fed to the address book to be displayed.

16. The computer readable storage medium of claim 11, wherein the related news articles and the related sales items are displayed on the address book as an icon.

17. The computer readable storage medium of claim 16, wherein the icon is selectable for redirecting to a host hosting the news article and the sales item.

18. The computer readable storage medium of claim 16, wherein the icon is configured to be one of a menu and a list when a plurality of news articles and sales items are found.

19. The computer readable storage medium of claim 18, wherein the instructions are further operable to:
extend a field of search of the respective sources as a function of an indirect connection to the data of the address book.

20. A feed system, comprising:
a news feeding means for accessing news sources to find related news articles as a function of data in an address book; and
a sales feeding means for accessing sales sources to find related sales items as a function of the data in the address book,
wherein at least one of the news feeding means and the sales feeding means forwards the related news articles and the related sales items, respectively, to the address book to be displayed.
